(19) United States
(12) Patent Application Publication
(10) Pub. No.: US 2014/0314269 A1
(43) Pub. Date: Oct. 23, 2014

(54) DEVICE, SYSTEM AND METHOD FOR RECOGNIZING ACTION OF DETECTED SUBJECT

(71) Applicant: Peng Chen, Beijing (CN)

(72) Inventor: Peng Chen, Beijing (CN)

(73) Assignee: Beijing Inforson Technologies Co., Ltd., Beijing (CN)

(21) Appl. No.: 13/381,002

(22) PCT Filed: Dec. 12, 2011
(86) PCT No.: PCT/CN11/83828

§ 371 Date: Jul. 2, 2014

(30) Foreign Application Priority Data
Sep. 14, 2011 (CN) 201110270835.5

(51) Int. Cl. G06K 9/00

(52) U.S. Cl. CPC G06K 9/00335; G06K 9/00624
USPC 382/103

(57) ABSTRACT

The present disclosure discloses a device, a system and a method for recognizing the action of a detected subject. The device includes an input section for the user to input scene mode selected among a plurality of scene modes; a detection section for detecting the action of the detected subject and outputting an action signal when the device is disposed on the subject; and a microprocessor for processing the action signal according to the selected scene mode, to recognize and output the action of the detected subject in different scene modes. The system includes a device and a terminal, wherein the device is used to recognize the action of the detected subject based on a scene mode selected through the terminal by a user; and the terminal is used to display the action recognition result. The method includes recognizing the action based on a scene mode selected by a user.

### CROSS REFERENCE TO RELATED APPLICATION

This application is a U.S. National Phase application of PCT International Application PCT/CN2011/083828, filed Dec. 12, 2011, which claims priority from Chinese Application No. 201110270835.5, filed Sep. 14, 2011, the contents of each of which are incorporated herein by reference in their entirety for all purposes.

### FIELD OF THE INVENTION

The present disclosure relates to a device, a system and a method for recognizing the action of a detected subject, and more particularly, to a device, a system and a method for accurately recognizing the action of a detected subject in different scene modes.

### BACKGROUND OF THE INVENTION

Recently, people are paying more and more attention to their health condition, and they desire to be able to monitor and record the actions of their bodies using some tools, and then further analyze quality and intensity of the actions.

Technologies for automatically recognizing the action of a user have been known.

Japanese patent No. JP 2000-245713 discloses a device for automatically recognizing the action of the human body, comprising a wristwatch type sensor, provided with a temperature sensor and a pulse sensor and an acceleration sensor, is connected to a personal computer equipped with a display; and a behavior classification judging section for classifying and judging the action sensed by the sensor, for example, sleeping, eating and drinking, stress, physical exercises and resting, etc, and then the judged action type is displayed on the display.

US patent No. US2009/0082699 discloses an apparatus and a method for recognizing daily activities of a user, which improves the correctness of recognizing daily activities of the user by redefining the action classification of the detected subject. And the apparatus includes some action sensors attached to the user for detecting the action of the detected subject, and some pressure sensors mounted on indoor objects such as a piece of furniture; and an action classification module for receiving action signals from the action sensors and classifying the action type according to the duration time of the action, and thereby generating action classification values; and an action classification redefining module for receiving the action classification values from the action classification module and response signals of the objects from the pressure sensors, and comparing the action classification values and the response signals, to redefine the action type.

However, the above described prior arts only teach to recognize the action of the user in one type of scene mode, i.e., a daily life scene mode, but can not recognize the action of the user in other types of scene modes. Furthermore, the prior arts can only recognize the action without particular sequence, but they can not recognize a series of actions inparticular sequence.

### SUMMARY OF THE INVENTION

In view of the defects of the prior art, one object of the present disclosure is to provide a device, a system and a method for accurately recognizing the action of any detected subject in various scene modes.

For achieving the above aim, the present disclosure provides a device for accurately recognizing the action of the detected subject, comprising:

an input section for a user to input a scene mode selected among a plurality of scene modes;

a detection section for detecting the action of the detected subject and outputting an action signal when the user disposes the device on the detected subject; and

a microprocessor for processing the action signal according to the selected scene mode, to recognize and output the action of the detected subject in different scene modes.

Wherein the device further comprises a storage section for storing scene models corresponding to the plurality of the scene modes;

the microprocessor recognizes the action of the detected subject according to the scene model corresponding to the selected scene mode, and stores an action recognition result in the storage section.

Wherein the device further comprises an output section for instructing the user to dispose the device on a corresponding portion of the detected subject after the selection of the scene mode by the user.

Wherein the scene mode comprises one or combination of a scene mode with demonstration action and a scene mode without demonstration action; the scene mode with demonstration action is corresponding to a scene model with demonstration action, and the scene mode without demonstration action is corresponding to a scene model without demonstration action; the scene model with demonstration action comprises a plurality of sub-scene models respectively corresponding to a plurality of time intervals.

Wherein the device further comprises an output section for outputting the action of the detected subject in the scene mode without demonstration action, and instructing, based on the process result of the microprocessor, the detected subject one or combination of the following information in the scene mode with demonstration action:

an action type, a performance level of a performed action, and how to perform the action to reach a standard performance level.

Wherein the detection section comprises one or combination of an acceleration sensor, a gyroscopes sensor, an angular rate sensor, a height sensor, an image sensor, an infrared sensor, and a position sensor.

Wherein the scene model comprises a sampling rate parameter of the sensor, a feature weight parameter, and an action classification algorithm.

Wherein the action classification algorithm in the sub-scene model comprises a standard action model and a nonstandard action model.

Wherein the sensor samples the action signal based on the sampling rate parameter and transmits the sampled action signal to the microprocessor, wherein the microprocessor comprises a recognition unit, wherein the recognition unit comprising:

a feature extracting unit for extracting features from the sampled action signal and assigning a feature weight to the extracted features according to the feature weight parameter; and

a classification unit for classifying, based on the action classification algorithm, the extracted features assigned with the feature weight to recognize the action.

Wherein the scene mode without demonstration action comprises at least one of a golf scene mode, an office scene mode, a somatic scene mode, a gymnasium scene mode, an elder care scene mode, a children care scene mode, a car driving scene mode, and a bridge health monitoring scene mode;

the scene mode with demonstration action comprises at least one of a yoga scene mode with demonstration action, an golf scene mode with demonstration action, a Tai chi scene mode with demonstration action, and a tennis scene mode with demonstration action.

Wherein the storage section is further used to store the action recognition result.

Wherein the detected subject includes the human body, an animal, a robot, or an object.

Further, the present disclosure provides a system for recognizing the action of a detected subject, comprising: a device and a terminal; wherein

the device recognizes the action of the detected subject based on a received scene mode selected through the terminal by a user; and

the terminal outputs an action recognition result.

Wherein the device comprises:

a detection section for detecting the action of the detected subject and outputting a corresponding action signal; and

a microprocessor for processing the action signal according to the selected scene model, to recognize the action of the detected subject in different scene modes.

Wherein the terminal comprises a storage section for storing scene models corresponding to a plurality of the scene modes.

Wherein the device is used to receive, when a scene mode is selected by the user, a corresponding scene model from the terminal in a wireless or wired way; and

the microprocessor is used to recognize the action of the detected subject according to the received scene model and sends the action recognition result to the terminal.

Wherein the terminal is further used to instruct the user to dispose the device on a corresponding portion of the detected subject depending on the type of the selected scene mode.

Wherein the scene mode comprises a scene mode with demonstration action and a scene mode without demonstration action; the scene mode with demonstration action is corresponding to a scene model with demonstration action, and the scene mode without demonstration action is corresponding to a scene model without demonstration action;

the scene model with demonstration action comprises a plurality of sub-scene models respectively corresponding to a plurality of time intervals.

Wherein the terminal is used to output the action recognition result in the scene mode without demonstration action, and instruct, when the detected subject performs a demonstration action, the detected subject one or combination of the following information in the scene mode with demonstration action:

the action recognition result, a performance level of the performed demonstration action, and how to perform the action to reach a standard performance level according to the process result of the microprocessor.

Wherein one or more devices are provided;

the terminal is used to instruct the user to dispose each of the devices on a corresponding portions of the detected subject after the selection of the scene mode by the user;

the scene model comprises a plurality of portion scene models respectively corresponding to a plurality of portions of the detected subject;

each of the plurality of portion scene models comprises a sampling rate parameter of the sensor, a feature weight parameter, and an action classification algorithm.

Wherein after finishing disposing the devices on the corresponding portions of the detected subject, the terminal is used to send the portion scene models to the one or more corresponding devices.

Wherein the system further comprises a server for storing scene models corresponding to the plurality of scene modes.

Wherein after the selection of the scene mode by the user, the terminal sends the scene model corresponding to the selected scene mode stored in the server to the device in a wireless or wired way.

Further, the present disclosure provides a method for recognizing the action of a detected subject, comprising:

receiving a scene mode selected among a plurality of scene modes by a user;

detecting an action signal of the detected subject in the selected scene mode; and

processing the action signal according to the selected scene mode, to recognize the action of the detected subject in different scene modes.

Wherein after receiving the selected scene mode, the user is instructed to dispose a device on a corresponding portion of the detected subject.

Wherein the scene mode comprises one or combination of a scene mode with demonstration action and a scene mode without demonstration action.

Wherein the method further comprises outputting an action recognition result in the scene mode without demonstration action, and instructing, when the detected subject performs a demonstration action, the detected subject one or combination of the following information in the scene mode with demonstration action:

the action recognition result, a performance level of the performed demonstration action, and how to perform the action to reach a standard performance level.

Wherein the action signal of the detected subject is processed according to the scene model corresponding to the selected scene mode.

Wherein the action signal of the detected subject is detected in the selected scene mode using a sensor; and the scene model comprises a sampling rate parameter of the sensor, a feature weight parameter, and an action classification algorithm.

Wherein the sensor samples the action signal according to the sampling rate parameter of the sensor.

Wherein the method further comprises:

a feature extracting step for extracting the features from the sampled action signal, and assigning weights to the extracted features according to the feature weight parameter; and

a classification step for classifying the features assigned with weights according to the action classification algorithm to recognize the action.

Other features, objects and advantages of the present disclosure will become more apparently and easily understandable through describing the preferable embodiments of the present disclosure with reference to the appending figures.

### BRIEF DESCRIPTION OF THE DRAWINGS

FIG. 1 illustrates a block diagram of an action recognition device according to a first embodiment of the present disclosure.

FIG. 2 illustrates a flowchart of an action recognition method according to the embodiment of the present disclosure.

FIG. 3 illustrates an example of a scene mode list according to the embodiment of the present disclosure.

FIG. 4 illustrates a block diagram of a microprocessor in the device of FIG. 1.

FIG. 5 illustrates a flowchart of process of the action signal of the microprocessor of FIG. 4.

FIG. 6 illustrates an action recognition device according to a second embodiment of the present disclosure.

FIG. 7 illustrates an action recognition system according to a first embodiment of the present disclosure.

FIG. 8 illustrates an action recognition system according to a second embodiment of the present disclosure.

In all the foregoing figures, the same number represents the same/similar parts, or corresponding features or functions.

### DETAILED DESCRIPTION OF THE INVENTION

A device, a system and a method for recognizing the action of the present disclosure will be described in detail with reference to the appending figures.

FIG. 1 illustrates a block diagram of an action recognition device 100, in accordance with one embodiment of the present disclosure.

The device 100 may be a portable device, which may be disposed on any portion of the human body, an object or a robot, etc, for example on a wrist, a waist, a ankle, a leg of the human body or a robot, etc. And the human body described herein may be the user himself or herself, or any others being detected by the user, e.g., a child, an elder or a patient, etc, who has trouble to move freely. And the device 100 may also be disposed on a detected object, which may be, e.g., a golf club, a tennis racket, a badminton racket, a car, a bridge, a shoe, etc, to detect the action of the detected object.

As shown in FIG. 1, the device 100 comprises a detection section 101, an input section 102, a microprocessor 103, and a storage section 104. Wherein the storage section 104 may be configured outside of the microprocessor 103, or also be integrated with the microprocessor 103.

Wherein the detection section 101 may be used to detect the action of the detected subject. The detection section 101 may be one or more sensors known to those skilled in the art, such as an acceleration sensor, a gyroscope, an angular rate sensor, a height sensor, an infrared sensor, an image sensor, etc. Preferably, the detection section 101 of the present disclosure may be a tri-axial acceleration sensor, and an A/D convertor may be integrated with or arranged outside of the tri-axial acceleration sensor. And the tri-axial acceleration sensor may sample, based on a predefined sampling rate, a series of action signal in three different directions (three axis), and output the sampled action signal to the microprocessor 103. For accurately recognizing the action of the detected subject, the detection section 101 of the present disclosure may also include various kinds of sensors described above, to overall detect a position, a height, an angle, an orientation, a movement status, and an action image of the detected subject, and classify the type of the action based on the detection result. For example, when the detected subject is walking, if its height rises continuously, then the action of the detected subject may be recognized as “climbing a hill” or “climbing stairs”; when the detected subject is practicing tennis, if the joints of its arms change, then the action of the detected subject may be judged as “swing”; if a car is moving, and the orientation of the car changes, then the action of the car may be judged as “changing the orientation.

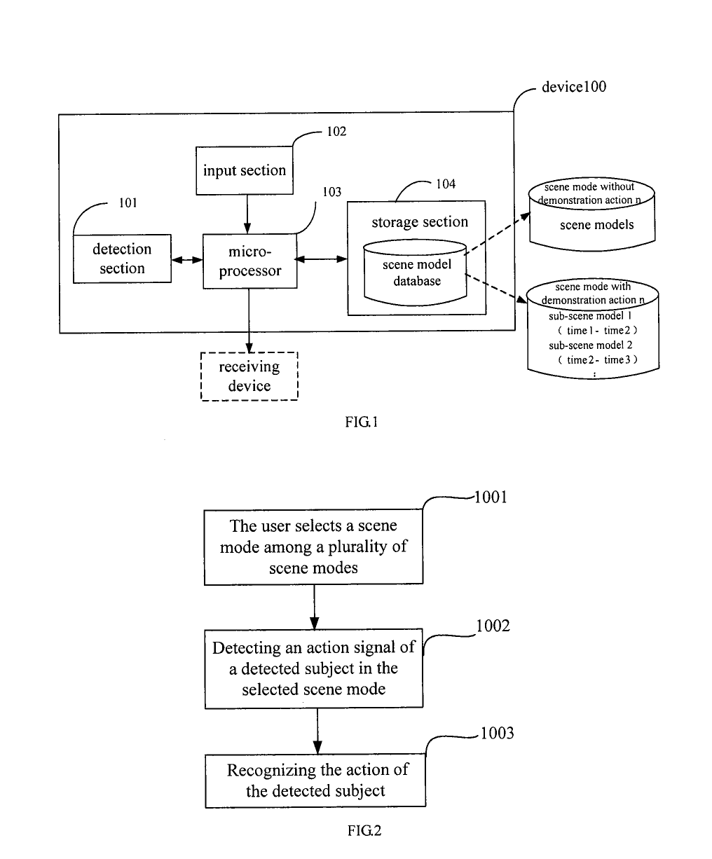

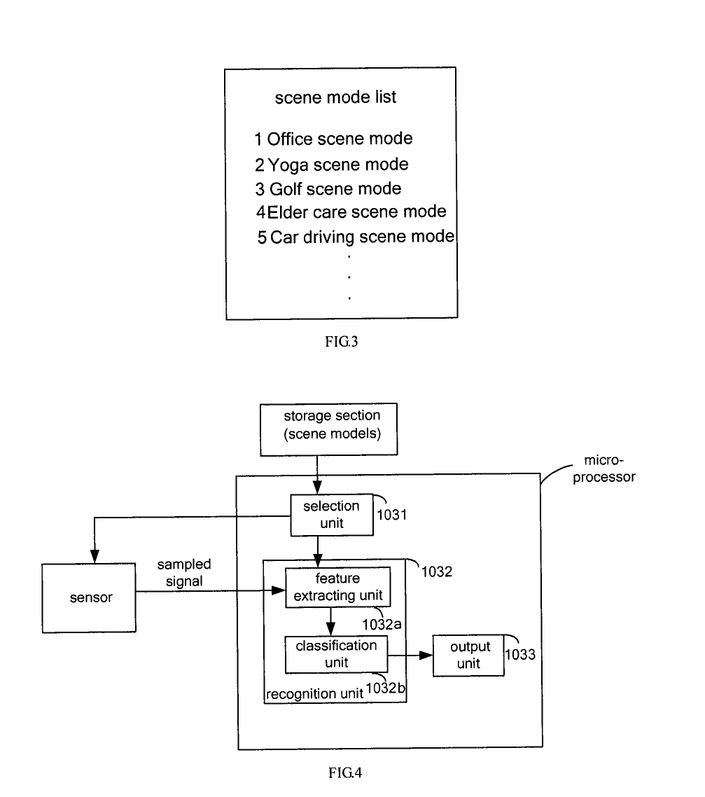

Preferably, the detection section 101 may also include a position sensor for detecting the position of the detected subject. And the position sensor may be, for example, a Global Positioning System (GPS) module, a Compass module, a GLONASS module, a Galileo module known in the art, etc. The device 100 further includes an input section 102. A flowchart shown in FIG. 2, during the step 1001, which shows that the user may select, through the input section 102, a scene mode from a scene mode list provided by the microprocessor 103. Wherein the scene mode may be, for example, an office scene mode, a yoga scene mode, a golf scene mode, an elder care scene mode, and a car driving scene mode etc., shown in FIG. 3. It is noted that the scene mode of the present disclosure may not limit to the scene mode shown in FIG. 3, but also include other various scene modes not shown in the scene mode list. Wherein the input section 102 may be a touch screen, a keyboard, or a button, etc.

The microprocessor 103 may be used to perform action recognition processing based on the scene model corresponding to the selected scene mode. Wherein the storage section 104 may be used to store scene models corresponding to a plurality of scene modes.

After the selection of the scene mode by the user, during step 1002, as shown in FIG. 2, the detection section 101 may detect the action signal of the detected subject in the selected scene mode, and output a detected action signal to the microprocessor 103.

And then during step 1003, the microprocessor 103 may search for, based on the selected scene mode, the corresponding scene model from a plurality of scene models stored in the storage section 104. And then the microprocessor 103 may process the received action signal according to the searched scene model, to recognize the action of the detected subject. The processing of the microprocessor 103 will be described in the following detailed description.

According to a preferable embodiment of the present disclosure, the scene mode may comprise two types of scene modes, which are a scene mode without demonstration action and a scene mode with demonstration action.

The scene mode without demonstration action refers to the scene mode in which the detected subject may not need to perform a series of consecutive actions following a set of demonstration actions. It may include but not limited to, for example, a golf scene mode without demonstration action, an office scene mode, a somatic game scene mode, a gymnasium scene mode, an elder care scene mode, a children care scene mode, a car driving scene mode, and a bridge health monitoring scene mode, etc. For example in the office scene mode, the type of the action of the detected subject may mainly include “stand”, “walk”, “run”, “lie”, “sit”, and “fall”; in the home scene mode, the type of the action of the detected subject may mainly include various actions in daily life, for example, “mopping the floor”, “cleaning the window”, “feeding the pets”, and “cooking”, etc; in the somatic game and gymnasium scene mode, the type of the action of the detected subject may mainly include various actions in the game and gymnasium; in the elder and children care scene mode, the user may dispose the device 100 on the elder or children to monitor the abnormal actions of the elder or children, like “falling down”, “falling to the ground”, etc.

The scene mode with demonstration action refers to the scene mode in which the detected subject needs to perform a series of consecutive actions following a set of demonstration actions. And the type of the scene mode with demonstration action may include but not limited to, for example, a yoga scene mode with demonstration action, a golf training scene mode with demonstration action, a Tai chi training scene mode with demonstration action, a tennis training scene mode with demonstration action, etc. For example, in the yoga scene mode, the detected subject needs to perform a set of yoga actions following a set of demonstration actions, e.g., “preparing action”->“arms stretching”->“arms raising”->“resume”, and such similar multiple consecutive actions with a particular sequence. The demonstration actions may be recorded in a video or audio file stored in the compact disc of the device 100, a paper file, or may be live demonstrated by a coach to the detected subject.

It is noted that in the golf scene mode or badminton scene mode with demonstration action or without demonstration action, the user may also dispose the device 100 on the club instead of on human body to indirectly detect the action of the detected subject manipulating the clubs, and the type of the action may mainly include “static”, “swing” of the clubs, etc. Similarly, in the office scene mode, the somatic game scene mode, the gymnasium scene mode, the elder care scene mode, and the children care scene mode, the user may dispose the device 100 on corresponding portions of the shoes put on the human body who are doing sports, and the action type may mainly include “move”, “static”, and “fall” of the shoes, etc; in the car-driving scene mode, the user may dispose the device 100 on a particular position in a car, e.g., fixedly installed in the middle of the steering wheel, and the types of the action may mainly include “the driving direction of the car, “acceleration”, and “deceleration”, etc.

In the bridge health monitoring scene mode, the device 100 may be disposed on various portions of the bridge to monitor the vibration of the bridge to detect the health situation of the bridge.

Particular scene models are preset corresponding to various types of the scene modes according to the embodiment of the present disclosure, to recognize the action of the detected subject in different scene modes.

In the scene mode without demonstration action, the corresponding scene model may be only one scene model, as shown in FIG. 1.

In the scene mode with demonstration action, because the action of the detected subject shall be divided into consecutive sub-actions over a period of time, the corresponding scene model of the present disclosure may include a plurality of sub-scene models. Each of those sub-scene models is divided according to a plurality of time intervals of the period of time, i.e. time1-time2, time2-time3 . . . , as shown in FIG. 1. For example, in the yoga scene mode, the detected subject needs to perform a set of consecutive actions which will last for about ten minutes, and then the corresponding scene model shall consist of a plurality of sub-scene models which are respectively corresponding to a plurality of time intervals divided by the ten minutes, e.g., 0-4 seconds, 4-7 seconds, 7-12 seconds . . . until the end of the demonstration action. Wherein the time interval is divided based on the time period that each sub-action belongs to, and set based on an empirical value or the experimental amount from a plurality of experiments.

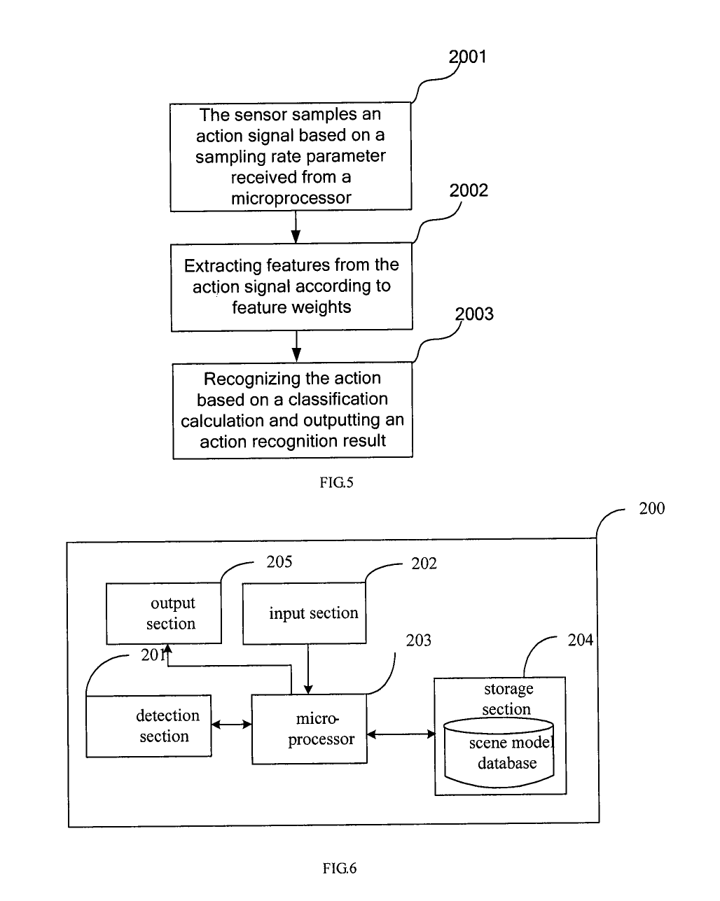

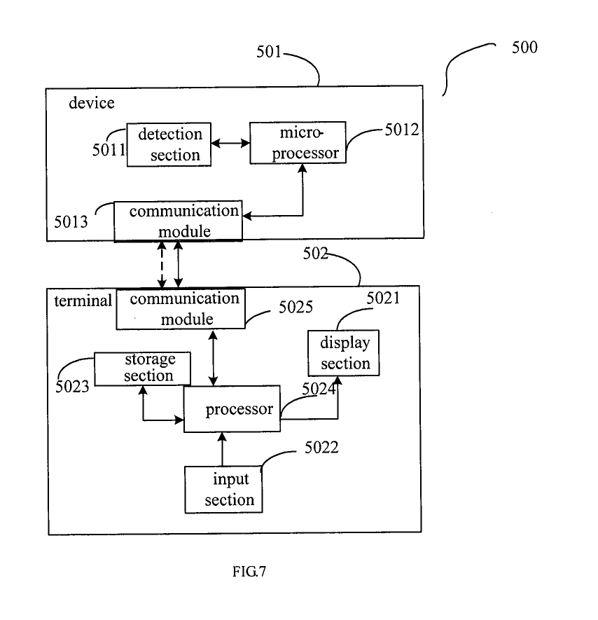

According to the embodiment of the present disclosure, the microprocessor 103 may be configured to process the action signal once every time interval and output the processing result via an output section (shown in FIG. 6.) in real time. Wherein in the scene mode without demonstration action, the time interval may be preset to 4 seconds, or shorter or longer than 4 seconds; And in the scene mode with demonstration action, it may be predetermined according to how frequently the action of the detected subject changes, e.g., if the action of the detected subject changes very frequently, then the time interval may be predetermined in a range from 1 to 2 seconds, and if the action of the detected subject changes not so frequently, then the time interval may be predetermined to 4 seconds, etc.

Furthermore, the scene model of the present disclosure may include a sampling rate parameter of the sensor, the feature weight parameter and an action classification algorithm.

Wherein the sampling rate parameter of the sensor may be respectively predetermined according to different scene modes. For example, in the office scene mode, the sampling rate parameter may be preset, for example, in a range from 30 Hz to 80 Hz; in the golf scene mode, the sampling rate parameter may be preset, for example, in a range from 200 Hz to 1000 Hz; in the yoga scene mode, the sampling rate parameter may be preset, for example, at 50 Hz in the first sub-scene model corresponding to the time interval of 0-4 seconds, and preset, for example, at 70 Hz in the second sub-scene mode corresponding to the time interval of 4-7 seconds . . . , and so on.

Wherein the feature weight parameter may be a weight factor being assigned to the features extracted from the action signal. The extracted features may include the features both in time domain and in frequency domain, wherein the features in the time domain may include, e.g., a mean, a variance, a short-term energy, an autocorrelation coefficient and a cross-correlation coefficient, a signal period, etc. And the extracted features in the frequency domain may include a cross-correlation coefficient, Mel Frequency Cepstrum Coefficient (MFCC) of the frequency domain converted from the action signal by means of the Fast Fourier Transformation (FFT), etc. A n-dimension feature may be extracted from the action signal. For convenience of description, assuming three dimensions (herein labeled as “A”, “B”, and “C”) of the feature described above, respectively corresponding to the features A, B, and C, have been extracted, the feature weights may be assigned as a, b, and c. And the values of the feature weights a, b, and c may be preset to 0 or 1 to delete or hold the extracted features. And the values of a, b and c may be preset to other various numbers based on highlighting or neglecting the importance of the extracted features.

Wherein common action classification algorithms known to those skilled in the art may be applied to classify the type of action of the detected subject. Wherein only one type of action classification algorithm, such as Gaussian classifier, may be applied as the action classification algorithm.

By setting different algorithm parameters corresponding to different scene modes, various types of action in the scene modes may be classified.

For example, when using Single Gaussian Model (SGM) as the action classification algorithm, the algorithm function is as follows:

$$N ( x , μ , \sum ) = \frac{1}{\sqrt{( 2 π ) \vert \sum \vert}} exp [ - \frac{1}{2} {( x - μ )}^{T} {\sum }^{- 1} ( x - μ ) ]$$

Wherein x represents an extracted n-dimension feature, μ represents a mean of the SGM, and Σ represents a variance of the SGM. By training the SGM, the action models corresponding to different actions may be determined. The extracted features assigned with the feature weights may be input into various action models set by the action classification algorithms, and then to recognize the type of the action using the action classification algorithms.

Also, the type of the actions may be recognized by using different action algorithms known in the art for different scene modes. For example, in the office scene mode, the Gaussian Mixed Model (GMM) may be used to classify the type of the action. In the yoga scene mode, the Bayesian Network model may be used to classify the type of the action; in the golf scene mode, the artificial nerve network model may be used to classify the type of the action, etc. Wherein on training the action models of various action classification algorithms, a maximum likelihood and a maximum posterior probability algorithm known in the art may be used to estimate the model parameters, to obtain more accurate parameter estimations.

Now referring to FIG. 4 and FIG. 5, based on the scene models corresponding to different scene modes, the action recognition processing of the microprocessor 103 will be described in detail below.

As shown in FIG. 4, the microprocessor 103 may further include a selection unit 1031, a recognition unit 1032, and an output unit 1033, wherein the recognition unit 1032 may further include a feature extracting unit 1032a and a classification unit 1032b.

Firstly, in step 2001, as shown in FIG. 5, after reading out the corresponding scene model from the storage section 104, the selection unit 1031 in the microprocessor 103 transmits the sampling rate of the sensor in the scene model to the sensor, and then the sensor samples the action signal based on the sampling rate of the sensor. And then the action signal sampled by the sensor may be transmitted to the recognition unit 1032 in the microprocessor 103.

Subsequently, in step 2002, the feature extraction unit 1032a in the recognition unit 1032 may firstly extract features from the sampled action signal transmitted from the detection section 101, and then assign the feature weights to the extracted features according to the feature weight parameters in the scene model.

And then, in step 2003, according to the action classification algorithm in the scene model, the classification unit 1032b may be used to perform the classification calculation for the features assigned with the feature weights to recognize various types of the action and transmit the recognition result to the output unit 1033 for outputting the result.

It is apparently known to those skilled in the art that, the proper classification methods in various scene modes may be determined by training various kinds of various action models. Taking Gaussian classification algorithm for example, in the office scene mode, the action type may be classified as, for example, “sit”, “run”, and “walk” by means of training the Gaussian model, etc. Similar with that, in the golf scene mode without demonstration action, the action type may be classified as, for example, “swing” and “stroke”, by training the Gaussian model, etc. And in the car driving scene mode, the action type may be classified as “turn left”, “turn right”, “acceleration”, and “deceleration” by training the Gaussian model, etc.

In the scene mode with demonstration action, such as the yoga scene mode, a performance level of the action of the detected subject may be also classified by training a standard action Gaussian model and a non-standard action Gaussian model, other than classifying the actions as various types of action by training the Gaussian model. Wherein the non-standard action Gaussian model may consist of a plurality of non-standard action models, to distinguish various performance levels.

For example, in the yoga scene mode, the action in the sub-scene mode corresponding to 0-4 seconds may be classified as follows:

“standard stretch action”;

“typical erroneous action 1, no stretching arms”;

“typical erroneous action 2, no starting to move”;

“atypical erroneous action”, etc.

And the similar way may applied to all the sub-scene models respectively corresponding to 0-4 seconds, 4-7 seconds, 7-12 seconds . . . until the end of the action.

Similarly, the action in various scene modes may be classified as required by training a plurality of Gaussian models.

The action recognition algorithm of the present disclosure has been described with reference to Gaussian model. It is apparently known to those skilled in the art that, other types of models may also be used as the action recognition algorithm.

Furthermore, the microprocessor 103 may also output the action recognition result to a receiving device (referring to the dotted-line block in FIG. 1), e.g., a mobile phone, etc.

The configuration of the device 100 and the action recognition methods according to the first embodiment of the present disclosure have been described above in detail.

FIG. 6 illustrates a second embodiment of the present disclosure. The devices that have similar functions with the device 100 of the first embodiment of the present disclosure will not be repetitively described herein. The device 200 of the present disclosure may further include an output section 205, and the selection of the scene mode may be realized by selecting a scene mode from a selectable scene mode list by instructing the user via the output section 205. The output section 205 may be a display, e.g., a liquid crystal display, for displaying one scene mode list shown in FIG. 2. And the user may select a scene mode from the scene mode list through the input section 202. And the output section 205 may also be an audio signal output section, for outputting an acoustic signal to instruct the user the type of the selectable scene mode. And when the user hears a prompt tone of the corresponding scene mode, the user may input a confirmation command through the input section 202. And thus, the user may eventually select a scene mode.

Furthermore, the output section 205 may also output the action recognition result provided by the microprocessor 203. Wherein in the scene mode without demonstration action, the output section 205 may output the recognized type of the action performed by the detected subject; in the scene mode with demonstration action, in addition to be able to output the recognized action type of the detected subject, the output section 205 may also output the performance level of the action performed by the detected subject or an instructing information, to instruct the detected subject how to perform the action to achieve the performance level. For example, in the yoga scene mode described above, the output section 205 may possibly output the action recognition result as follows:

In the case of “standard stretch action”, output “standard”.

In the case of “typical erroneous action 1, no raising arms”, output “you are not completely stretching your arms” or “please stretch your arms”.

In the case of “typical erroneous action 2, no starting action”, output “please start action”.

In the case of “atypical erroneous action”, output “please keep your action correct”, etc.

Advantageously, the scene model of the embodiment of the present disclosure may further include a portion disposing information. The output section 205 of the device 200 may instruct, through the microprocessor 203 depending on the portion disposing information in the scene model stored in the storage section 204, the user to dispose the device 200 on the corresponding portion of the detected subject, so as to accurately detect the action of the detected subject in the selected scene mode. For example, the output section 205 may be designed to instruct the user after the selection of the scene mode by the user. For example, when the user selects the yoga scene mode, then the output section 205 may instruct the user to dispose the device 200 onto the waist of, for example, the human body (e.g. the user himself or herself or other human body except for the user); and if the user selects the elder care scene mode, then the output section 205 may instruct the user to dispose the device 200, for example, on the elder's leg; when the user selects the bridge health monitor mode, then the output section 205 may instruct the user to dispose the device 200, for example, on various portions of the body of the bridge, etc.

Preferably, the device 200 may store in advance a demonstration action file which may be a video file, e.g. a MPEG4 file, in which a yoga demonstration action or other demonstration actions may be performed by a coach; or it may also be an audio file,e.g., a mp3 file, or a WAV file. etc, for instructing the yoga action by voice. The detected subject may perform the actions referring to the demonstration action files. After the user selecting the yoga scene mode through the input section 202, the microprocessor 203 plays, based on the selection command of the user, the foresaid audio or video files through the output section 205.

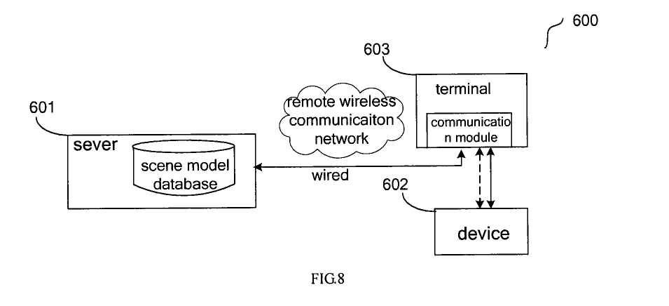

The present disclosure further discloses an action recognition system. FIG. 7 illustrates an action recognition system 500 according to one embodiment of the present disclosure, including a device 501 and a terminal 502, wherein the terminal 502 may be a mobile phone, a computer, a laptop, or a PDA, etc, which may communicate with the device 501 via a communication module in wireless or wired way. It is apparently known to those skilled in the art that the wireless way may be a ZIGBEE, Bluetooth, etc, and the wired way may be a USB interface, etc.

The terminal 502 may further include a display section 5021, an input section 5022, a storage section 5023, a processor 5024, and a communication module 5025.

Wherein the display section 5021 may be used to display the information provided by the processor 5024.

The input section 5022 may be used for the user to input one scene mode selected from the scene mode list provided by the processor 5024. And the scene mode may be any type of the scene modes described above.

The storage section 5023, similar with the foregoing storage section 104 and 204, may be used to store the scene models corresponding to different scene modes.

The processor 5024 may be used to select the corresponding scene model from the scene models stored in the storage section 5023 depending on the scene mode selected by the user, and send the selected scene model to the device 501 through the communication module 5025. And the device 501 may include a detection section 5011, a microprocessor 5012, and a communication module 5013.

Wherein the detection device 5011 may be used to detect the action signal of the detected subject and transmit the detected action signal to the microprocessor 5012.

The microprocessor 5012 in the device 501 may be used to perform the action recognition process to recognize the action of the detected subject in accordance with the action signals transmitted from the detection section 5011 and the scene model received from the terminal 502 through the communication module 5013, and then send the action recognition result to the processor 5024 of the terminal 502 through the communication module 5013. Wherein the process of the microprocessor 5012 is similar with the process of any one of the microprocessor 103 and 203 in the foregoing embodiments, and therefore no more details will be given.

And then, the processor 5024 may transmit the action recognition result to the display section 5021, and the display section 5021 may display the action recognition result so as to be useful for the user or the detected subject to view.

Preferably, the display section 5021 may also display one scene mode list shown in FIG. 3, and the user may select one scene mode from the scene mode list through the input section 5022.

Advantageously, the scene model of the embodiment of the present disclosure may further include a portion disposing information. The microprocessor 5012 in the device 501 may transmit the corresponding portion disposing information in the scene model to the processor 5024 in the terminal 502 through the communication module 5013, and the portion disposing information may be displayed to the user through the display section 5021. And the user may dispose the device 501 on the corresponding position of the detected subject in accordance with the potion disposing information, to accurately detect the action of the detected subject in the selected scene mode.

Preferably, the terminal 502 may store in advance a demonstration action file which may be a video file, e.g. a MPEG 4 file, in which a yoga demonstration action or other demonstration actions may be performed by a coach. And the detected subject may perform the actions referring to the demonstration action file. After the selection of the yoga scene mode by the user, the display section 5021 may play the foregoing video file.

FIG. 8 illustrates an action recognition system 600 in accordance with another embodiment of the present disclosure. Wherein the action recognition system 600 may include a server 601 for storing a plurality of scene models corresponding to a plurality of scene modes.

A device 602, which is similar with the device shown in FIG. 7.

A terminal 603, equipped with the similar parts of the terminal 502 shown in FIG. 6, and therefore no more details will be given. The difference is that the communication module in the terminal 603 may also have the function of communicating with the server 601.

Wherein the server 601 may communicate with the terminal 603 through a wireless telecommunication network, e.g., GPRS, 3G, 4G, WiFi, GSM, W-CDMA, CDMA, TD-SCDMA, etc, or via a wired way, e.g. USB interface, etc. And the user may select one scene mode through the terminal 603, and then the terminal 603 may download the corresponding scene model and send the downloaded scene model to the device 602 through the communication module.

The device 602 may recognize the action of the detected subject according to the scene model and transmit the action recognition result to the terminal 603. And then the terminal 603 may transmit the action recognition result to the server 601.

Thus, the user or the detected subject may remotely view the action of the detected subject. For example, the doctors may view whether the action of the elders, children and patients to be cared are abnormal or not, the coaches may view the action of the athletes during their training programs, and the bridge detector may view the vibration of the bridge, etc.

Preferably, the storage section 104 in the device 100 shown in FIG. 1 may also be a remote server. It is noted that both the device and the terminal may be configured with the scene models, or also may obtain the scene models from the server.

Preferably, the server 601 may store in advance a demonstration action file which may be a video file, e.g. a MPEG 4 file, in which a yoga demonstration action or other demonstration actions may be performed by a coach. The detected subject may perform the action referring to the demonstration action file. After the selection of the yoga scene mode by the user, the terminal may download the demonstration action file and display it the user through the communication module.

For accurately recognizing the action of the detected subject, the system 500 and the system 600 respectively shown in FIG. 7 and FIG. 8 may respectively include a plurality of devices 501 and 602 for being disposed on the various corresponding portions of the detected subject. And the scene models respectively corresponding to each of the scene mode may include a plurality of portion scene models for different portions of the detected subject. Taking the yoga scene mode for example, the yoga scene model may include three portion scene models respectively corresponding to the waist, the wrist, and the leg. After the user selected the yoga scene mode through the terminal, the terminal will instruct the user in sequence to respectively dispose three devices on the corresponding portions of the detected subject through the display section. For example, the terminal may firstly instruct the user to dispose the device on the wrist of the detected subject. Provided that the detected subject is the user himself or herself, the user shall put the device on the wrist, and then send a confirmation command, which may be performed through the user pressing a “confirmation” button displayed in the display section of the terminal, to the terminal. In such way, the terminal may instruct the user in order to dispose the device on the waist and the leg of the detected subject.

As each of the devices has its own device number as ID number, after the user disposed the device and confirmed that, the terminal will send the portionscene model in accordance with the device ID number. And then the microprocessor in the every device will respectively process the recognized action signal according to the received scene model and transmit the recognition result to the terminal.

In the scene mode without demonstration action, e.g. an office scene mode, each device will send the recognized action to the terminal, and the user or the detected subject will view the action of the detected subject through the terminal.

In the scene mode with demonstration action, e.g., a yoga scene mode, each device will send the type of the action and performance level of the action thereof of the first embodiment, or an instructing information for how the detected subject performs the action correctly to reach a standard performance level to the terminal. And the user or the detected subject may view these information through the terminal in real time, to standardize the action of the detected subject.

Preferably, the device and the terminal according to the embodiments of the present disclosure may also store the action information of the detected subject, to record the behavior history or the action data of the detected subject, so as to be convenient for the user or the detected subject to view and analyze the action or the behavior history of the detected subject.

It is pointed out that the foregoing description represents the preferable embodiments of the present disclosure. For those skilled in the art, it will be understood that various modifications and substitutions, which will be considered to fall into the scope of the present disclosure, may be made therein without departing from the principles of the present disclosure.

1. A device for recognizing the action of a detected subject, comprising:
an input section for a user to input a scene mode selected among a plurality of scene modes;
a detection section for detecting the action of the detected subject and outputting an action signal when the user disposes the device on the detected subject; and
a microprocessor for processing the action signal according to the selected scene mode, to recognize and output the action of the detected subject in different scene modes.

2. The device according to claim 1, further comprising a storage section for storing scene models corresponding to the plurality of the scene modes; wherein
the microprocessor recognizes the action of the detected subject according to the scene model corresponding to the selected scene mode, and stores an action recognition result in the storage section.

3. The device according to claim 1, further comprising an output section for instructing the user to dispose the device on a corresponding portion of the detected subject after the selection of the scene mode by the user.

4. The device according to claim 2, wherein
the scene mode comprises one or combination of a scene mode with demonstration action and a scene mode without demonstration action;
the scene mode with demonstration action is corresponding to a scene model with demonstration action, and the scene mode without demonstration action is corresponding to a scene model without demonstration action;
the scene model with demonstration action comprises a plurality of sub-scene models respectively corresponding to a plurality of time intervals.

5. The device according to claim 4, further comprising an output section for outputting the action of the detected subject in the scene mode without demonstration action, and for instructing, based on the process result of the microprocessor, the detected subject one or combination of the following data in the scene mode with demonstration action:
an action type, a performance level of a performed action, and how to perform the action to reach a standard performance level.

6. The device according to claim 4, wherein the detection section comprises one or combination of an acceleration sensor, a gyroscopes sensor, an angular rate sensor, a height sensor, an image sensor, an infrared sensor, and a position sensor.

7. The device according to claim 6, wherein the scene model comprises a sampling rate parameter of the sensor, a feature weight parameter, and an action classification algorithm.

8. The device according to claim 7, wherein the action classification algorithm in the sub-scene model comprises a standard action model and a nonstandard action model.

9. The device according to claim 6, wherein the sensor samples the action signal based on the sampling rate parameter and transmits the sampled action signal to the microprocessor; wherein the microprocessor comprises a recognition unit, wherein the recognition unit comprises:
a feature extracting unit for extracting features from the sampled action signal and assigning a feature weight to the extracted features according to the feature weight parameter; and
a classification unit for classifying, based on the action classification algorithm, the extracted features assigned with the feature weight to recognize the action.

10. (canceled)

11. A system for recognizing the action of a detected subject, comprising a device and a terminal;
wherein the device recognizes the action of the detected subject based on a received scene mode selected through the terminal by a user; and
the terminal outputs an action recognition result.

12. (canceled)

13. The system according to claim 11, wherein
the terminal comprises a storage section for storing scene models corresponding to a plurality of scene modes.

14. The system according to claim 13, wherein the device comprises:
a detection section for detecting the action of the detected subject and outputting a corresponding action signal; and
a microprocessor for processing the action signal according to the selected scene model, to recognize the action of the detected subject in different scene modes;
wherein the device is used to receive, when a scene mode is selected by the user, a corresponding scene model from the terminal in a wireless or wired way; and
the microprocessor is used to recognize the action of the detected subject according to the received scene model and sends the action recognition result to the terminal.

15. The system according to claim 11, wherein
the terminal is further used to instruct the user to dispose the device on a corresponding portion of the detected subject depending on the type of the selected scene mode.

16. The system according to claim 11, wherein
the scene mode comprises a scene mode with demonstration action and a scene mode without demonstration action;
the scene mode with demonstration action is corresponding to a scene model with demonstration action, and the scene mode without demonstration action is corresponding to a scene model without demonstration action;
the scene model with demonstration action comprises a plurality of sub-scene models respectively corresponding to a plurality of time intervals.

17. The system according to claim 16, wherein
the terminal is used to output the action recognition result in the scene mode without demonstration action, and instruct, when the detected subject performs a demonstration action, the detected subject one or combination of the following information in the scene mode with demonstration action:
the action recognition result, a performance level of the performed demonstration action, and how to perform the action to reach a standard performance level according to the process result of the microprocessor.

18. The system according to claim 11, wherein
one or more devices are provided;
the terminal is used to instruct the user to dispose each of the devices on corresponding portions of the detected subject after the selection of the scene mode by the user;
the scene model comprises a plurality of portion scene models respectively corresponding to a plurality of portions of the detected subject;
each of the plurality of portion scene models comprises a sampling rate parameter of the sensor, a feature weight parameter, and an action classification algorithm.

19. The system according to claim 18, wherein
after finishing disposing the devices on the corresponding portions of the detected subject, the terminal is used to send the portion scene models to the one or more corresponding devices.

20. The system according to claim 11, further comprising a server for storing scene models corresponding to the plurality of scene modes.

21. The system according to claim 20, wherein after the selection of the scene mode by the user, the terminal sends the scene model corresponding to the selected scene mode stored in the server to the device in a wireless or wired way.

22. A method for recognizing the action of a detected subject, comprising:
receiving a scene mode selected among a plurality of scene modes by a user;
detecting an action signal of the detected subject in the selected scene mode; and
processing the action signal according to the selected scene mode, to recognize the action of the detected subject in different scene modes.

23. The method according to claim 22, wherein
after receiving the selected scene mode, the user is instructed to dispose a device on a corresponding portion of the detected subject.

24. The method according to claim 23, wherein
the scene mode comprises one or combination of a scene mode with demonstration action and a scene mode without demonstration action.

25. The method according to claim 24, further comprising:
outputting an action recognition result in the scene mode without demonstration action; and
instructing, when the detected subject performs a demonstration action, the detected subject one or combination of the following information in the scene mode with demonstration action:
the action recognition result, a performance level of the performed demonstration action, and how to perform the action to reach a standard performance level.

26. The method according to claim 22, wherein
the action signal of the detected subject is processed according to the scene model corresponding to the selected scene mode.

27. The method according to claim 26, wherein
the action signal of the detected subject is detected in the selected scene mode using a sensor;
the scene model comprises a sampling rate parameter of the sensor, a feature weight parameter, and an action classification algorithm.

28. The method according to claim 27, wherein the sensor samples the action signal according to the sampling rate parameter of the sensor.

29. (canceled)
